(19) United States
(12) Patent Application Publication
(10) Pub. No.: US 2026/0116684 A1
(43) Pub. Date: Apr. 30, 2026

(54) Transport Unit for a Device for Handling Value Notes

(71) Applicant: Diebold Nixdorf Systems GmbH, Paderborn (DE)

(72) Inventors: Alexander Uhl, Paderborn (DE); Michael Schild, Paderborn (DE); Hermann Hoeschen, Paderborn (DE); Richard Düsterhus, Paderborn (DE)

(21) Appl. No.: 19/146,300

(22) PCT Filed: Jan. 9, 2024
(86) PCT No.: PCT/EP2024/050363

§ 371 Date: Sep. 4, 2025

(30) Foreign Application Priority Data
Jan. 10, 2023 (EP) 23150989.4

(51) Int. Cl. B65H 5/36; G07D 7/005; G07D 11/16

(52) U.S. Cl. CPC B65H 5/36; G07D 7/005; G07D 11/16; B65H 2404/693; B65H 2601/11; B65H 2701/1912; G07D 2211/00

(57) ABSTRACT

A transport unit for a device for handling notes of value, comprises first and second transport path limiting elements, which are arranged and spaced apart relative to one another such that a transport path is formed between the transport path limiting elements and notes of value can be transported along the transport path. The transport unit also comprises at least one sensor for identifying security features of the notes of value. The transport unit also comprises at least one guide element which is moveably arranged and can be moved at least between two positions, wherein, in a first position, the guide element is arranged at least partially in the transport path and is designed to limit the height of the transport path in a detection region of the sensor at a first distance, and in a second position, the guide element is not arranged in the transport path.

### BACKGROUND

### 1. Field

The invention relates to a transport unit for a device for handling value documents, as well as a method for removing a jam of value documents in the transport unit.

### 2. Description of Related Prior Art

In devices for handling value documents, the transport of value documents within the device can lead to jams of value documents. Jams of value documents occur, for example, when one or more value documents become jammed or are pulled diagonally in the transport unit of the device. A value document jam can then lead to a blockage of a transport path of the device's transport unit. It is known that value document jams can be largely avoided by generously dimensioning the transport paths of the device. In particular, the transport paths can be designed so that they are high enough to transport even crumpled value documents without causing a jam of value documents. This also makes it possible to transport multiple value documents that could not be separated safely along the transport paths without causing value document jams.

However, it is not always possible to ensure a sufficient height of the transport path. In order to ensure successful identification of security-relevant features, it is necessary, for example, to pass value documents over the corresponding sensors at a short distance. In some regions of the transport paths, the height of the transport path must be significantly reduced. Depending on the condition of the value documents to be transported, these bottlenecks provide a high potential for value document jams. If a value document jam occurs at these bottlenecks, the problem remains that these value document jams cannot be cleared without the intervention of maintenance personnel, meaning that the operation of the device is no longer possible and must be interrupted.

### SUMMARY

The object of the invention is to provide a transport unit for a device for handling value documents and a method for clearing a value document jam, which can avoid or eliminate a value document jam at bottlenecks.

A transport unit for a device for handling value documents comprises a first transport path limiting element and a second transport path limiting element, which are arranged and spaced apart relative to one another in such a way that a transport path is formed between the transport path limiting elements and value documents can be transported along the transport path. Furthermore, the transport unit comprises at least one sensor which is designed to identify at least one security feature of the value documents transported along the transport path. Furthermore, the transport unit comprises at least one guide element which is movably arranged and can be moved at least between two positions, wherein in a first position the guide element is arranged at least partially in the transport path and is further designed to limit the height of the transport path in a detection region of the sensor at a first distance, wherein in a second position the guide element is not arranged in the transport path.

When transporting a value document, the transport path limitation elements are located in particular opposite the front and back side of the value document.

The guide element allows a value document to be guided particularly close to the sensor during transport along the transport path.

It is particularly preferred if the detection region of the sensor is directed at least through an opening of the first transport path limiting element onto the transport path. This allows the security features of the value document to be determined particularly accurately and reliably.

Preferably the sensor is a magnetic sensor. This allows magnetic security features of the value document, especially magnetic inks, to be detected.

Preferably, the sensor is arranged flush with a side of the first transport path limiting element facing the transport path. This ensures safe transport of the value documents along the transport path.

It is advantageous if the guide element in the first position projects into the transport path through at least one opening of the second transport path limiting element. This allows the guide element to be positioned opposite the sensor in the transport path and guide value documents close to the sensor.

It is particularly advantageous if the second transport path limiting element is set back from the transport path in the region of the opening, in particular is concave, and the guide element in its second position is arranged at least partially flush with a side of the second transport path limiting element facing the transport path in said region. This allows the guide element to either form a bottleneck or open the transport path.

It is advantageous if a contact region of the guide element for contact with the value document is arranged to be movable transversely to a transport direction of the value documents along the transport path between the first and the second position, in particular the guide element extends substantially over a width of the transport path transversely to the transport direction. Furthermore, the contact region has a convex shape, particularly on a side facing the transport path. This allows the value document to be guided past the sensor particularly safely during transport along the transport path, especially when the guide element is in its first position.

It is advantageous if the guide element is held in the first position by means of a spring force exerted by a spring element or is spring-mounted. This allows the guide element to be moved, particularly by bent value documents or in the case of multiple withdrawals, thus preventing a jam of value documents in the region of the guide element.

It is advantageous if the guide element can be moved at least into the second position by means of a lifting magnet. This allows the guide element to be moved particularly flexibly.

It is advantageous if the guide element can be moved at least between the first position and the second position by means of a motor. This allows the guide element to be moved particularly flexibly.

Preferably, the sensor and the guide element are arranged along a plane transversely or perpendicularly to the transport path. In particular, also the detection region of the sensor extends over at least part of the width of the transport path. This ensures that the value document is guided past the sensor particularly safely during transport along the transport path.

Preferably the first distance has a value in a range of 0.5 mm to 1.5 mm, in particular of 1 mm. In particular, this also corresponds to a distance between the sensor and the guide element or the contact region of the guide element. This enables the sensor to identify the security features of the value document particularly accurately.

Preferably, the first transport path limiting element is at a distance from the second transport path limiting element in a range of 2 mm to 4 mm, preferably in a range of 2.5 mm to 3.5 mm, in particular of 3 mm. This prevents value document jams.

Preferably, the first transport path limiting element is at a distance from the second transport path limiting element in a first transport path region arranged before the detection region of the sensor in the transport direction in a range of 2 mm to 4 mm, preferably in a range of 2.5 mm to 3.5 mm, in particular of 3 mm, and wherein the first transport path limiting element is at a distance from the second transport path limiting element in a range of 1 mm to 2 mm, in particular of 1.5 mm, in a second transport path region arranged after the detection region in the transport direction. This allows additional sensors in the transport direction downstream of the guide element to detect features of the value document particularly reliably.

Preferably, the transport unit comprises a second sensor which is designed to identify at least one security feature of value documents transported through the second transport path region. The second sensor can in particular be an optical sensor. This allows for particularly secure verification of the value document.

It is advantageous if the transport unit comprises drive elements for transporting the value documents along the transport path. For this purpose, transport elements, for example driven rollers or wheels, can protrude into the transport path through the transport path limiting elements, in particular on both sides. This enables particularly secure transport of the value documents along the transport path.

A further aspect relates to a method for removing a value document jam in a transport unit, comprising the following steps: detecting a value document jam with at least one value document along a transport path of the transport unit: moving a guide element of the transport unit from a first position within the transport path to a second position outside the transport path; and transporting the value document against a transport direction.

It is preferred if, in step a) of the method, the value document jam is determined if a parameter of a drive motor for transporting the value document along the transport path deviates from an average value or if, after a predetermined time, the value document is not detected by a sensor arranged downstream of the transport unit in the transport direction. This allows a value document jam to be identified reliably and quickly.

A further aspect relates to a device for handling value documents comprising at least one transport unit with a guide element having the aforementioned features.

Preferably, the device for handling value documents comprises a control unit which is designed and configured to control at least the guide element according to the method.

### BRIEF DESCRIPTION OF THE DRAWINGS

Further features and advantages will become apparent from the following description, which explains in detail exemplary embodiments, in conjunction with the accompanying figures.

In particular:

FIG. 1 shows a schematic side view of a device for handling value documents,

FIG. 2 shows a side view of a transport unit of the device for handling value documents,

FIG. 3 shows a perspective view of a guide element and a transport path limiting element of the transport unit,

FIG. 4 shows a side view of the transport unit with the guide element in a first position and a lifting magnet,

FIG. 5 shows a side view of the transport unit according to FIG. 4 with the guide element in a second position,

FIG. 6 shows a detailed view of the guide element of the transport unit in the first position,

FIG. 7 shows a detailed view of the guide element of the transport unit in the second position,

FIG. 8 shows a side view of the transport unit according to a second embodiment with the guide element in a first position and a motor,

FIG. 9 shows the transport unit according to FIG. 8 with the guide element in a second position,

FIG. 10 shows a perspective view of the transport unit according to a third embodiment with a guide element in a first position,

FIG. 11 shows a perspective view of the transport unit according to FIG. 10 with the guide element in a second position,

FIG. 12 shows a detailed view of the guide element of the transport unit according to FIG. 10 in a first position,

FIG. 13 shows a detailed view of the guide element of the transport unit according to FIG. 12 in a second position, and

FIG. 14 shows a time course diagram with parameters of actuators and sensors of a transport unit.

### DETAILED DESCRIPTION

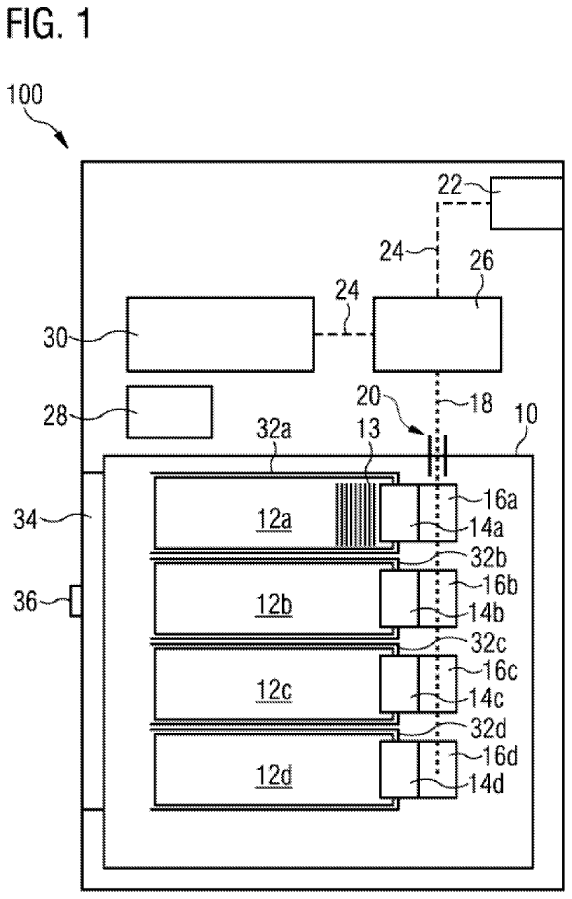

FIG. 1 shows a schematic side view of a device 100 for handling value documents. The device 100 serves both for the deposit of value documents by an operator and for the payout of value documents to an operator and is also referred to as a recycling ATM. Alternatively, the device 100 can also serve exclusively for the payout of value documents or the deposit of value documents. Furthermore, the device 100 can be an automatic cash register system, a self-checkout cash register or a so-called automatic teller safes.

The device 100 comprises a safe 10 in which four cash boxes 12a to 12d are arranged and which protects the cash boxes 12a to 12d from unauthorized access, in particular from theft and attempts at manipulation. The safe 10 has a safe door 34 which can be opened and closed via a locking unit 36. The cash boxes 12a to 12d are each arranged in a storage compartment 32a to 32d in the safe 10. In the embodiment according to FIG. 1, the cash boxes 12a to 12d are arranged horizontally in the device 100. In other devices for handling value documents, the cash boxes 12a to 12d may alternatively be arranged vertically.

The cash boxes 12a to 12d can be removed from the device 100 and are used for storing and transporting value documents, in particular banknotes and/or checks. The value documents are stored in the cash boxes 12a to 12d in the form of a stack. One of these stacks is indicated in the first cash box 12a, for example. For example, one of the value documents in this stack of value documents is designated by the reference numeral 13. In the operating position of the cash boxes 12a to 12d shown in FIG. 1, the value documents 13 in the cash boxes 12a to 12d are arranged standing on one of their edges, preferably on one of their longitudinal edges.

Each cash box 12a to 12d has an opening for feeding in value documents 13 and for withdrawing value documents 13. In front of the opening of a cash box 12a to 12d, a separating and stacking unit 14a to 14d is arranged, with the aid of which, on the one hand, value documents 13 can be fed to the cash boxes 12a to 12d and, on the other hand, value documents 13 stored in the cash boxes 12a to 12d can be separated from stacks of value documents held in the cash boxes 12a to 12d and withdrawn from the cash box 12a to 12d. In front of each separating and stacking unit 14a to 14d, a switch 16a to 16d is arranged, with the aid of which a value document 13 to be fed to the cash boxes 12a to 12d is branched off from a transport path 18 and fed to the separating and stacking unit 14a to 14d which is arranged in front of the cash box 12a to 12d into which the value document 13 is to be transported.

Likewise, the switches 16a to 16d serve to transport value documents 13 removed from the cash boxes 12a to 12d to the transport path 18. The safe 10 further has an opening 20 through which value documents 13 transported along the transport path 18 can be transported into the safe 10 or out of the safe 10.

Furthermore, the device 100 comprises an input and output compartment 22 via which value documents 13 to be deposited by an operator into the device 100 and value documents 13 to be paid out can be output to an operator. In the case of a pure dispensing ATM, only the dispensing of value documents 13 takes place via the input and output compartment 22: in the case of a pure depositing ATM, only the depositing of value documents 13 takes place via the input and output compartment 22.

The value documents 13 deposited via the input and output compartment 22 are separated and fed individually along the transport path 24 to a reading unit 26, with the aid of which, for example, the authenticity, the nominal value and/or the serial number of each deposited value document 13 can be determined. Furthermore, deposited and/or paid-out value documents 13 can be temporarily stored in a buffer 30. In particular, the buffer 30 can temporarily store value documents 13 unsuitable for payment and/or deposited value documents 13 identified by the reading unit 26 as not genuine or value documents 13 not removed by an operator.

In particular, when transporting value documents 13 along the transport paths 18, 24, jams of value documents can occur. Jams of value documents can occur particularly when value documents that are already in circulation and are crumpled, dirty or stuck together are transported along the transport paths 18, 24.

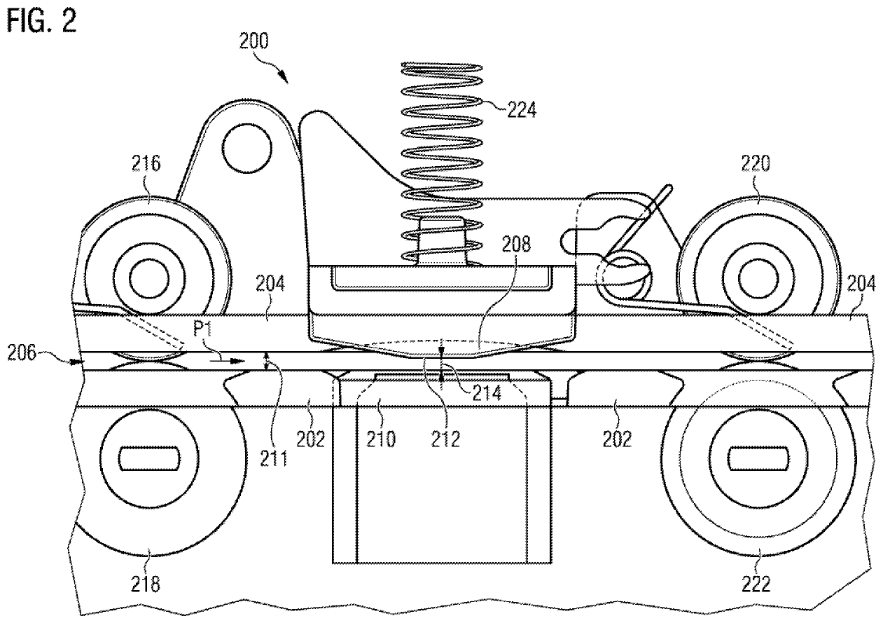

FIG. 2 shows a side view of a transport unit 200, in particular for the device 100 for handling value documents. The transport unit 200 can, for example, be arranged along one of the transport paths 18, 24. In particular, the transport unit 200 can be part of the reading unit 26, which serves to identify security features of the value documents 13.

The transport unit 200 comprises a first transport path limiting element 202 and a second transport path limiting element 204 between which a transport path 206 is formed. Along the transport path 206, value documents 13 can be transported in particular in a transport direction along the arrow P1. When transporting value documents 13 along the transport path 206, the transport path limiting elements 202, 204 are located opposite the front and back side of the respective value document 13. Furthermore, the transport unit 200 comprises a guide element 208 which, in a first position shown in FIG. 2, projects through an opening of the second transport path limiting element 204 into the transport path 206. In addition, the transport unit 200 comprises at least one sensor 210 which can identify security features of the value documents 13 transported along the transport path 206. In particular, the sensor 210 is arranged in an opening of the first transport path limiting element 202, so that the sensor 210 is arranged flush with a side of the first transport path limiting element 202 facing the transport path 206. Thus, the sensor 210 is arranged opposite the guide element 208 with respect to the transport path 206. A detection region of the sensor 210 is located in the transport path 206.

The first transport path limiting element 202 is at a distance 211 from the second transport path limiting element 204 in a range of 2 mm to 4 mm, preferably in a range of 2.5 mm to 3.5 mm, in particular of 3 mm. In the first position of the guide element 208 shown in FIG. 2, a contact region 212 of the guide element 208 is spaced from a side of the sensor 210 facing the transport path 206, in particular in the detection region of the sensor 210, or the side of the first transport path limiting element 202 facing the transport path 206, in a range of 0.5 mm to 1.5 mm, in particular 1 mm. The distance is marked with reference numeral 214. Thus, the distance 214 between the sensor 210 and the guide element 208 in its first position is in particular smaller than the distance between the transport path limiting elements 202, 204.

Normally, value documents 13 are guided along the transport path 206 in the direction of the arrow P1 through the transport unit 200. In particular, there is no contact between the value documents 13 and the transport path limiting elements 202, 204, the sensor 210 or the guide element 208, since the value documents 13 are each separated from the elements 202, 204, 208, 210 by an air gap. Only if the value documents 13 to be transported are, for example, heavily bent or if several value documents 13 are transported at once along the transport path 206 due to multiple withdrawals, can a fundamentally undesirable contact with the elements 202, 204, 208, 210 occur. Due to the reduced distance 214 compared to distance 211, it is therefore possible that value documents 13 get stuck at this bottleneck and a value document jam occurs.

Nevertheless, the reduced distance 214 is necessary in order to reliably identify or read security features of the value documents 13 with the aid of the sensor 210. The sensor 210 may in particular be a magnetic sensor that identifies magnetic features of the value documents 13 as the value documents 13 are transported past the sensor 210. For example, value documents 13 can be printed with magnetic printing ink, so that the printed images of magnetic printing ink are recognized with the aid of the sensor 210.

The transport unit 200 may comprise driven wheels 216, 218, 220, 222, by means of which value documents 13 can be transported along the transport path 206 and past the sensor 210. The guide element 208 can preferably be spring-mounted. For this purpose, the transport unit 200 comprises a spring 224 which holds the guide element 208 in the first position by means of a spring force.

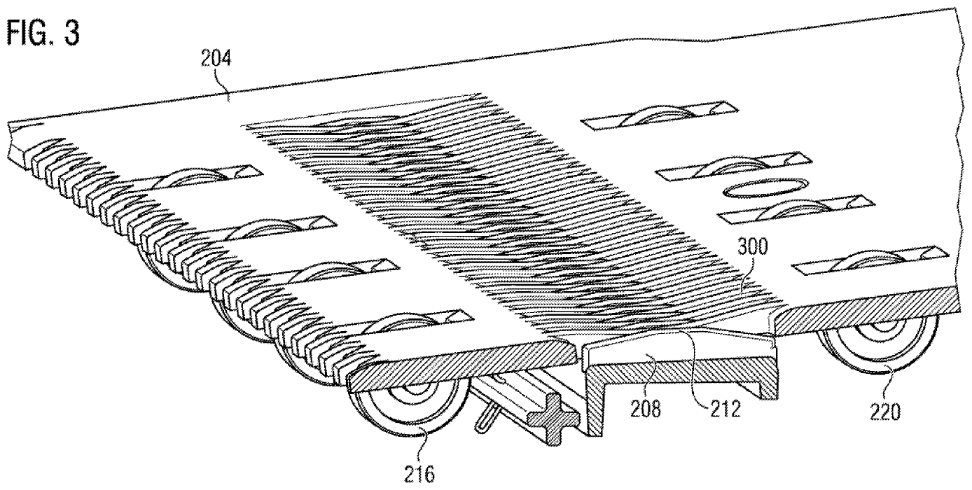

FIG. 3 shows a perspective view of the second transport path limiting element 204 with the guide element 208 in a second position. Elements that have the same structure and function are denoted by the same reference numeral. In the second position, the guide element 208 is pivoted out of the transport path 206. In this second position, the guide element 208 is arranged flush with the side of the second transport path limiting element 204 facing the transport path 206. In particular, the contact surface 212 of the guide element 208 is arranged flush. Furthermore, the guide element 208 can comprise a plurality of finger-shaped regions, each with one of the contact regions 212, which are each arranged between rib-shaped regions 300 of the second transport path limiting element 204. The rib-shaped regions 300 of the second transport path limiting element 204 are thus openings through which the finger-shaped regions of the guide element 208 can be introduced into the transport path 208. Furthermore, the rib-shaped regions 300 of the second transport path limiting element 204 can be set back on the side of the second transport path limiting element 204 facing the transport path 206 and can in particular be concave.

The guide element 208, in particular the contact regions 212, preferably have a rounded or convex shape, so that when the guide element 208 is arranged in the first position, in particular no edges on which value documents 13 can get caught protrude into the transport path 206 in and against the transport direction P1.

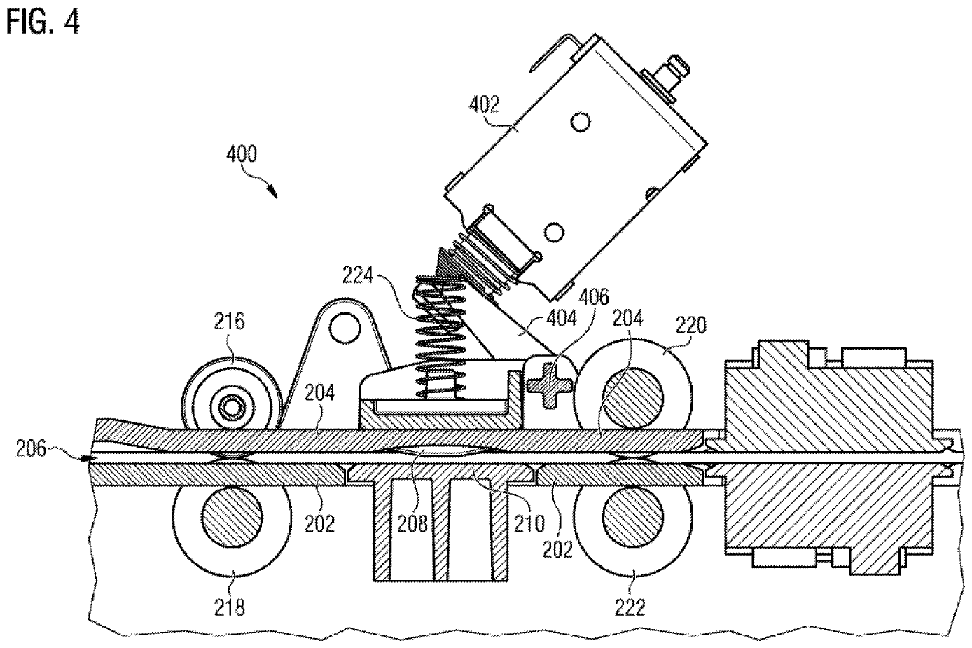

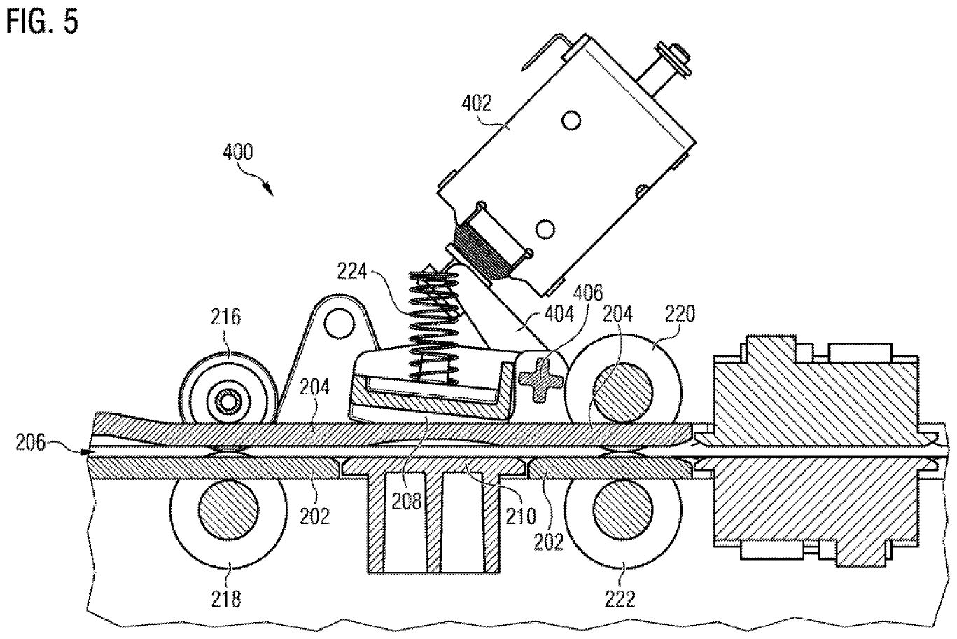

FIGS. 4 and 5 show a side view of a transport unit 400 with a lifting magnet 402, which is connected to the guide element 208 via a lever 404 and can pivot the guide element 208 from the first position shown in FIG. 4 about a rotation axis 406 into the second position shown in FIG. 5. The preferably spring-mounted guide element 208 can in particular also be moved into the second position when the lifting magnet 402 does not move the guide element 208 and a force opposite to and greater than the spring force acts on the guide element 208.

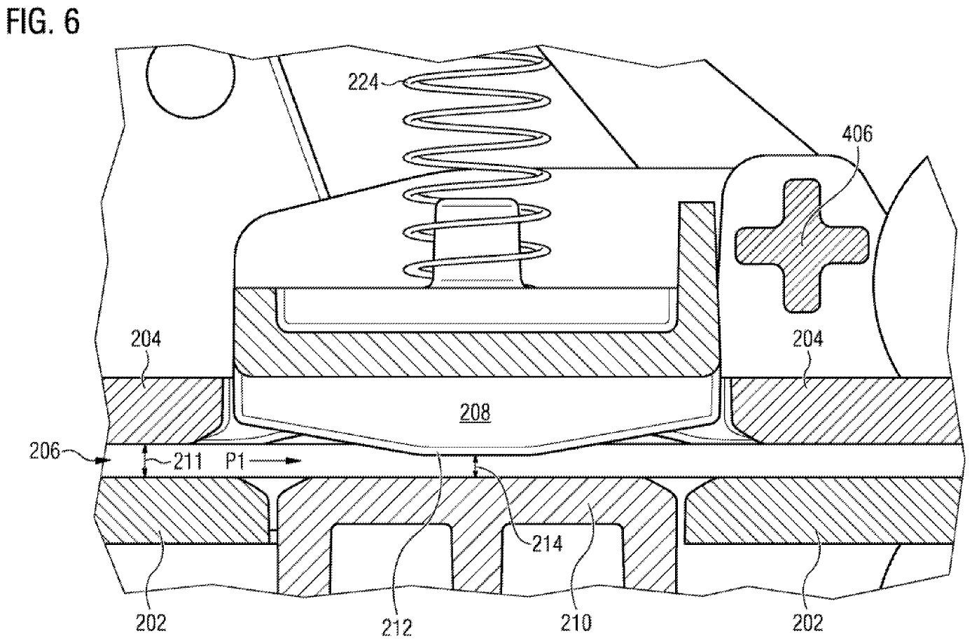

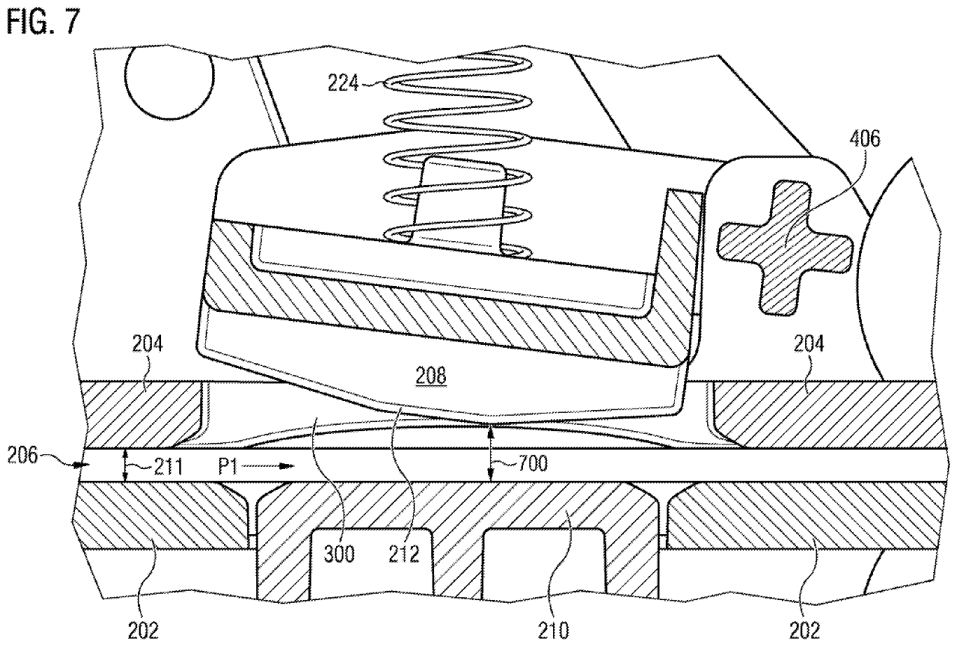

FIGS. 6 and 7 show detailed views of the guide element 208 of the transport unit 400 according to FIGS. 4 and 5, respectively. FIG. 6 shows the guide element 208 in the first position. The transport path 206 is limited to the distance 214 at the point at which the guide element 208 projects into the transport path 206 in order to guide value documents 13 close to the sensor 210, as already described above.

In the second position of the guide element 208 shown in FIG. 7, the distance 700 between the sensor 210 and the contact region 212 of the guide element 208 is increased compared to the first position. The distance 700 is in a range of 2 mm to 4 mm, preferably in a range of 2.5 mm to 3.5 mm, in particular 3 mm. Likewise, the transport path 206 is extended in the region between the guide element 208 and the sensor 210 and has a height equal to the distance 700. Thus, the height of the transport path 206 in the region between the guide element 208 and the sensor 210 is increased to the distance 700 when the guide element 208 is in the second position. Compared to the distance 211 between the first transport path limiting element 202 and the second transport path limiting element 204, the transport path 206 thus also increases in the region between the guide element 208 and the sensor 210. The bottleneck that occurs when the guide element 208 is in its first position can thus be avoided or eliminated by pivoting the guide element 208 into its second position.

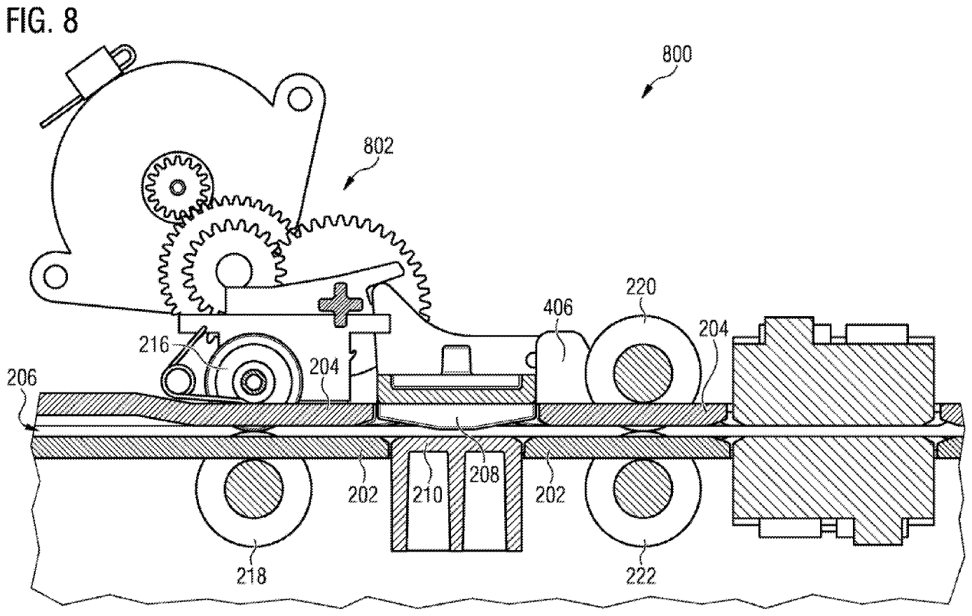

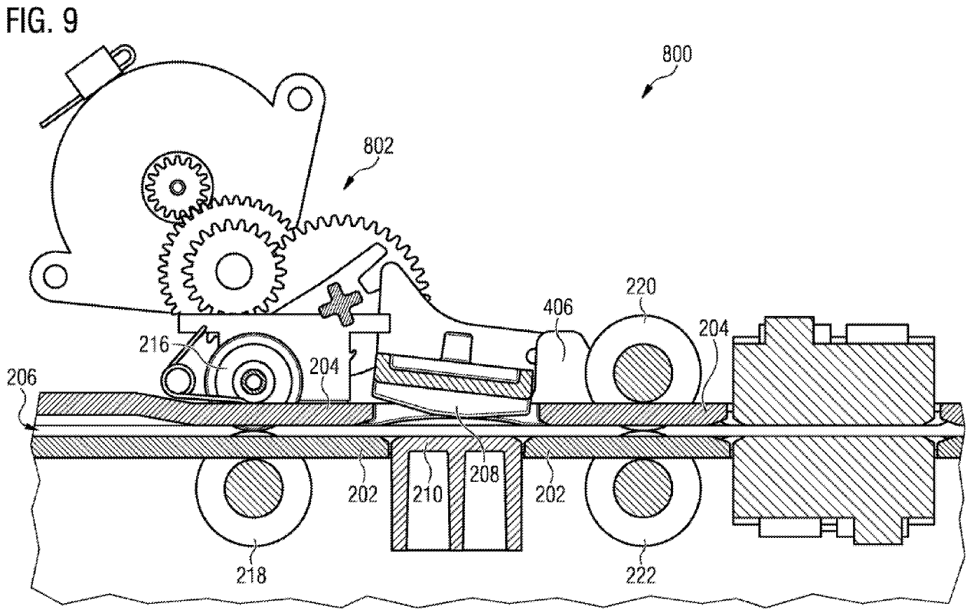

FIG. 8 and FIG. 9 show a transport unit 800. In contrast to the transport unit 400, the guide element 208 of the transport unit 800 can be moved from the first position shown in FIG. 8 to the second position shown in FIG. 9 with the aid of a motor via a gear or can be pivoted about the rotation axis 406.

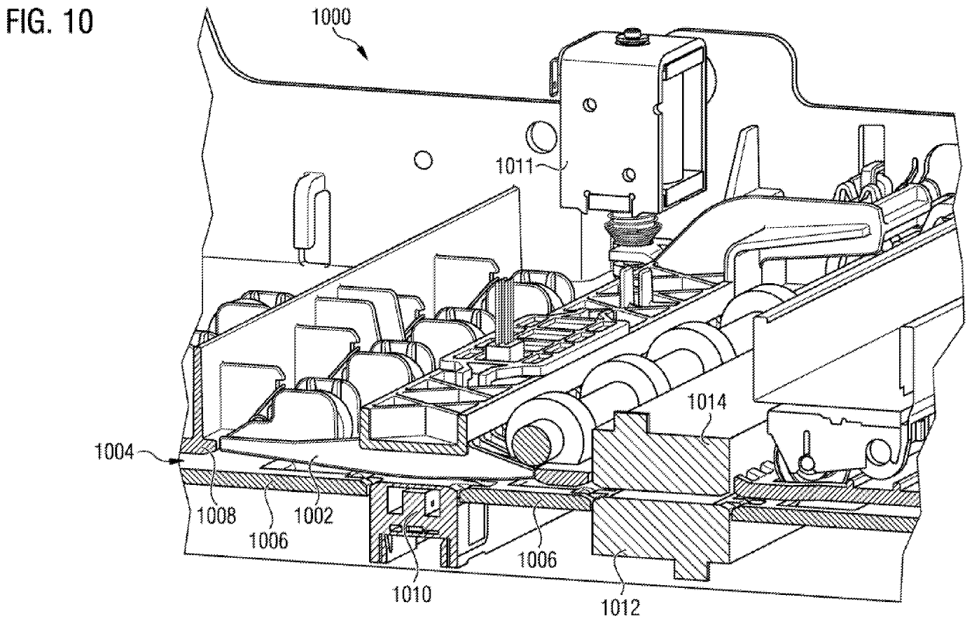

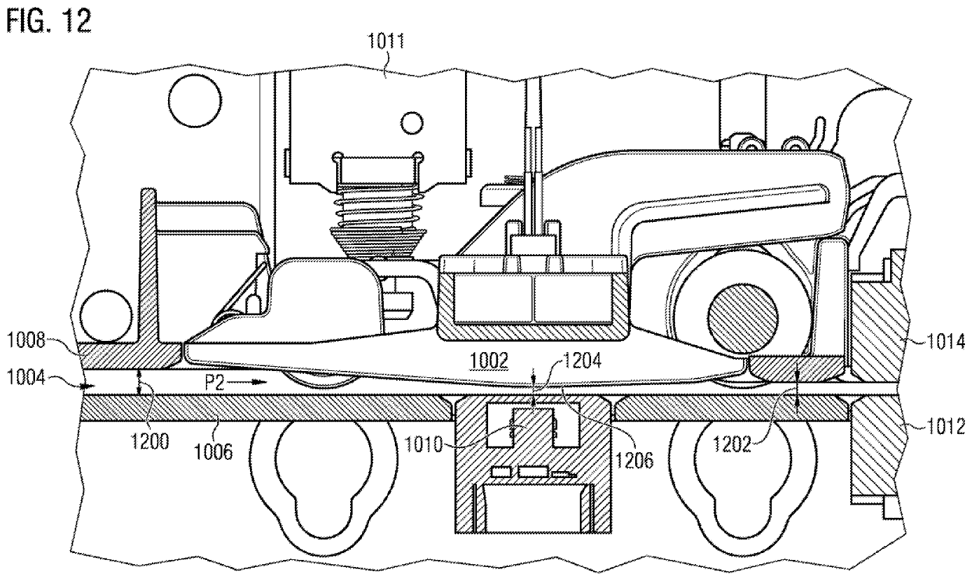

FIGS. 10 to 13 show sectional views of a transport unit with a guide element 1002. The transport unit 1000 has the same functions as described above for the transport units 200, 400, 800. In FIGS. 10 and 12, the guide element 1002 is in a first position in which the guide element 1002 projects into a transport path 1004 for value documents 13 between a first transport path limiting element 1006 and a second transport path limiting element 1008. Furthermore, the transport unit 1000 comprises a sensor 1010 which can detect security features of the value documents 13 transported along the transport path 1004.

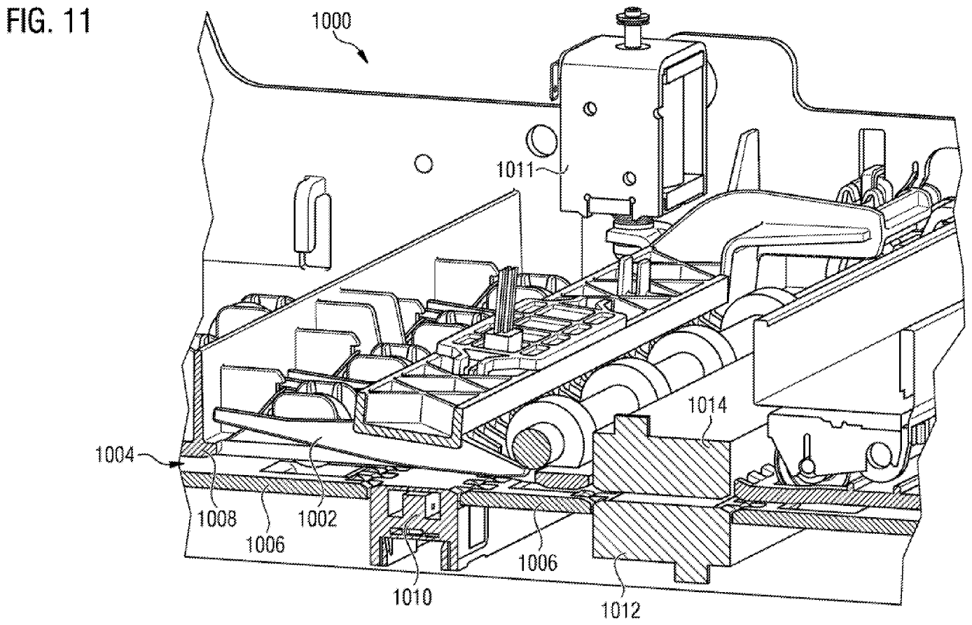

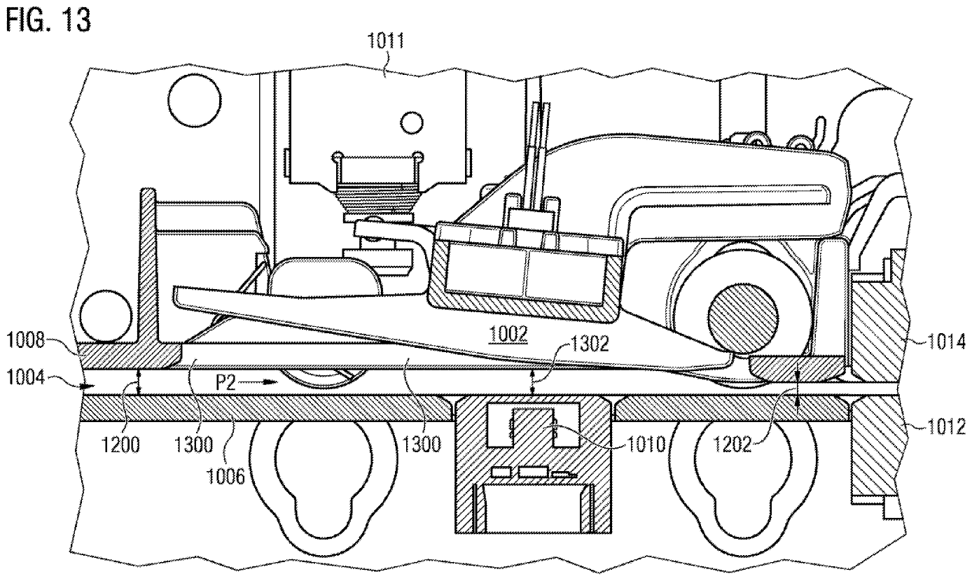

In FIGS. 11 and 13, the guide element 1002 is in a second position in which the guide element 1002 is arranged outside the transport path 1004.

The guide element 1002 can be moved between the positions of the guide element 1002 by means of a lifting magnet 1011.

In contrast to the transport units 200, 400, 800, the transport path limiting elements 1006, 1008 of the transport unit 1000 are variably spaced from one another. In a first transport path region, which is arranged before the guide element 1002 in the transport direction P2, the transport path limiting elements 1006, 1008 have a distance 1200 from each other. In a second transport path region, which is arranged after the guide element 1002 in the transport direction P2, the transport path limiting elements 1006, 1008 have a distance 1202 from each other. The distance 1200 is in a range of 2 mm to 4 mm, preferably in a range of 2.5 mm to 3.5 mm, in particular 3 mm. The distance 1202 is in a range of 1 mm to 2 mm, in particular 1.5 mm. Thus, the guide element 1002 is located at a transition between the distances 1200 and 1202 of the transport path limiting elements 1006, 1008. A distance 1204 of a contact region 1206 of the guide element 1202 in its first position from the sensor 1010, in particular a side of the sensor 1010 facing the transport path 1004 or in a detection region of the sensor 1010, is in a range of 0.5 mm to 1.5 mm, in particular 1 mm. Here, too, the guide element 1002 forms a bottleneck along the transport path 1004 in order to guide value documents close to the sensor 1010.

When the guide element 1002 is in its second position (in particular as shown in FIG. 13), the height 1302 of the transport path 1004 in the detection region of the sensor 1010 corresponds to the distance 1200 of the transport path limiting elements 1006, 1008 in the first transport path region. The bottleneck created by the guide element 1002 in its first position is thus increased or eliminated in its second position.

As described for FIG. 3, the guide element 1002 may have finger-shaped elements arranged between rib-shaped regions 1300 of the second transport path limiting element 1008.

The transport units 200, 400, 800, 1000 may further comprise additional sensors, in particular light barriers and cameras. By way of example, reference is made to FIGS. 10 to 13, in which a camera, in particular a spectral camera, with a first camera module 1012 and a second camera module 1014 of the transport unit 1000 is shown. The first camera module 1012 is arranged in an opening of the first transport path limiting element 1006 and directed towards the transport path 1004. The second camera module 1014 is arranged in an opening of the second transport path limiting element 1008 and directed towards the transport path 1004. The front and back side of value documents 13, which are transported along the transport path 1004, can thus be recorded simultaneously with the aid of the camera modules 1012, 1014.

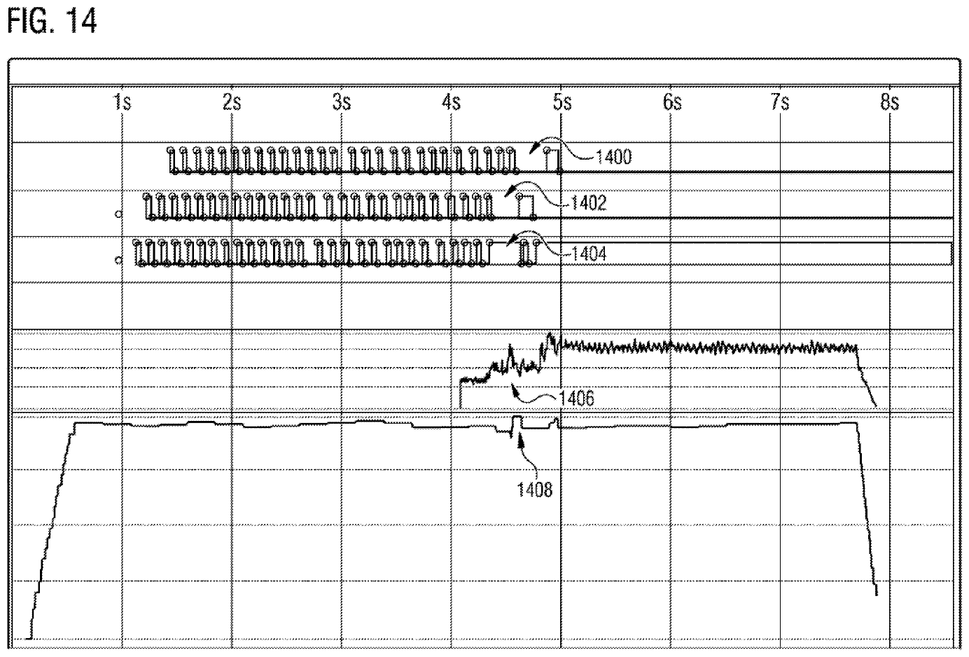

FIG. 14 shows a time course diagram with parameters of actuators and sensors of one of the transport units 200, 400, 800, 1000. Actuators can be, for example, drive motors for the driven wheels 216, 218, 220, 222. The sensors can be, for example, light barriers, the camera 1012, 1014 or the sensors 210, 1010. With the help of the parameters of actuators and sensors, value document jams can be determined and, based on this, the position of the guide elements 208, 1002 can be changed, in particular from the first to the second position. This way the bottleneck can be eliminated. The value document jam can then be cleared by transporting the value document(s) 13 causing the value document jam in the opposite direction to the transport direction P1, P2.

For example, parameters of light barriers or the camera 1012, 1014 can be used to detect value document jams. For this purpose, it can be determined whether a light barrier arranged in the transport direction P1, P2 after the bottleneck or the guide elements 208, 1002 is triggered by value documents 13 that were transported along the transport direction P1, P2 by the transport unit 200, 400, 800, 1000 or not. If the light barrier is not triggered after a predetermined time despite the expected value document 13, a value document jam can be detected.

FIG. 14 shows the course of light barrier signals which are regularly interrupted by properly transported value documents 13. In the periods 1400, 1402, 1404, the light barriers are not interrupted despite a transported value document 13, so that a value document jam is detected.

Additionally or alternatively, a value document jam can be detected when the motor current of the driven wheels 216, 218, 220, 222 has an increase 1406. Furthermore, a value document jam can be determined by a deviation 1408 of the rotational speed of the driven wheels 216, 218, 220, 222, or of the motor for the driven wheels 216, 218, 220, 222.

As soon as a value document jam is determined based on the parameters, the guide element 208, 1002 can be moved into the second position and the value document jam can thus be resolved, in particular by transporting the value documents 13 causing the jam against the transport direction P1, P2.

1. A transport unit for a device for handling notes of value, comprising:
a first transport path limiting element and a second transport path limiting element, which are arranged and spaced apart relative to each other such that a transport path is formed between the transport path limiting elements and notes of value can be transported along the transport path,
at least one sensor designed to identify at least one security feature of the notes of value transported along the transport path,
at least one guide element which is movably arranged and can be moved at least between two positions, wherein, in a first position, the guide element is arranged at least partially in the transport path and is designed to limit the height of the transport path in a detection range of the sensor at a first distance and, in a second position, the guide element is not arranged in the transport path, wherein the first transport path limiting element is at a distance in a range of from 2 mm to 4 mm from the second transport path limiting element in a first transport path region arranged upstream of the detection region in the transport direction, and wherein the first transport path limiting element is at a distance in a range of from 1 mm to 2 mm from the second transport path limiting element in a second transport path region arranged downstream of the detection region in the transport direction.

2. The transport unit according to claim 1, wherein the detection region of the sensor is directed at least through an opening in the first transport path limiting element.

3. The transport unit according to claim 1, wherein the sensor is arranged flush with a side of the first transport path limiting element facing the transport path.

4. The transport unit according to claim 1, wherein the guide element in the first position protrudes through at least one opening of the second transport path limiting element into the transport path.

5. The transport unit according to claim 4, wherein the second transport path limiting element is recessed out of the transport path in the region of the opening and the guide element is arranged in its second position flush with a side of the second transport path limiting element facing the transport path in said region.

6. The transport unit according to claim 1 wherein a contact region of the guide element for contact with the notes of value is arranged movably between the first and the second position transversely to a transport direction of the notes of value along the transport path, in particular the guide element extends substantially over the width of the transport path transversely to the transport direction.

7. The transport unit according to claim 1 wherein the guide element is held in the first position by means of a spring force exerted by a spring element.

8. The transport unit according to claim 1 wherein the guide element is movable at least into the second position by means of a lifting magnet.

9. The transport unit according to claim 1 wherein the guide element is movable by means of a motor at least between the first position and the second position.

10. The transport unit according to claim 1 wherein the first distance has a value in a range of 0.5 mm to 1.5 mm, in particular of 1 mm.

11.-12. (canceled)

13. A method for removing a note-of-value jam in a transport unit comprising the following steps:
a) determining a note-of-value jam containing at least one note of value along a transport path of the transport unit,
b) moving a guide element of the transport unit from a first position within the transport path to a second position outside the transport path, and
c) transporting the note of value against a transport direction.

14. The method according to claim 13, wherein, in step a), the note-of-value jam is determined if a parameter of a drive motor for transporting the note of value along the transport path deviates from an average value or if, after a predetermined time, the note of value is not determined by a sensor arranged downstream of the transport unit in the transport direction.

15.-16. (canceled)
